(19) United States
(12) Patent Application Publication
(10) Pub. No.: US 2026/0147151 A1
(43) Pub. Date: May 28, 2026

(54) DENSE LINEAR RAMP BRAGG GRATING PATTERN FOR QUENCH DETECTION IN HIGH TEMPERATURE SUPERCONDUCTING MAGNETS

(71) Applicant: Commonwealth Fusion Systems LLC, Devens, MA (US)

(72) Inventors: Owen Beals Duke, Austin, TX (US); Erica Elizabeth Salazar, Somerville, MA (US); Matthew Hicks, Marborough, MA (US)

(73) Assignee: Commonwealth Fusion Systems LLC, Devens, MA (US)

(21) Appl. No.: 19/300,801

(22) Filed: Aug. 15, 2025

Related U.S. Application Data
(63) Continuation of application No. PCT/US2024/015969, filed on Feb. 15, 2024.
(60) Provisional application No. 63/446,171, filed on Feb. 16, 2023.

(51) Int. Cl. G02B 6/02

(52) U.S. Cl. CPC G02B 6/02076

(57) ABSTRACT

Quench detection apparatuses and methods for high-temperature-superconducting (HTS) cables are described. An optical fiber may form part of the HTS cable and may include a plurality of fiber Bragg gratings (FBGs), at least some of which exhibit different center wavelengths. The FBGs are arranged in some embodiments such that the center wavelengths of the respective FBGs increase along the length of the HTS cable.

### CROSS-REFERENCE TO RELATED APPLICATIONS

This application is a continuation of International Patent Application Serial No. PCT/US 2024/015969 filed on Feb. 15, 2024, and titled “DENSE LINEAR RAMP BRAGG GRATING PATTERN FOR QUENCH DETECTION IN HIGH TEMPERATURE SUPERCONDUCTING MAGNETS,” which claims the benefit of U.S. Provisional Application Ser. No. 63/446,171 filed on Feb. 16, 2023, and titled “DENSE LINEAR RAMP BRAGG GRATING PATTERN FOR QUENCH DETECTION IN HIGH TEMPERATURE SUPERCONDUCTING MAGNETS,” each of which is incorporated herein by reference in its entirety.

### BACKGROUND

### Field

The present disclosure relates to quench detection in high-temperature-superconducting (HTS) cables such as those used in high temperature superconducting magnets.

### Related Art

High-temperature-superconducting (HTS) cables can experience quench. Fiber Bragg Gratings are sometimes used to detect quench.

### BRIEF SUMMARY

Some embodiments provide a high-temperature-superconducting (HTS) cable, comprising: a high-temperature superconductor; an optical fiber thermally coupled to the high-temperature superconductor and comprising a plurality of optical gratings having respective center wavelengths, wherein: the respective center wavelengths increase along a length of the HTS cable, and the respective center wavelengths differ from center wavelengths of nearest neighbor optical gratings by less than a full width at half max spectral response of the optical gratings.

In some embodiments, optical gratings of the plurality of optical gratings are arranged along the optical fiber such that respective center wavelengths of the optical gratings increase linearly along the length of the optical fiber.

In some embodiments, the optical fiber has a length greater than 50 meters and the plurality of optical gratings are spaced from nearest neighbor optical gratings by a distance in a range from 2 cm to 30 cm.

In some embodiments, the optical gratings of the plurality of optical gratings are fiber Bragg gratings.

In some embodiments, optical gratings of the plurality of optical gratings are spaced at a density of at least one optical grating per 20 cm.

In some embodiments, the high-temperature superconductor is a HTS tape stack.

In some embodiments, the HTS tape stack is embedded in a conductive former and the optical fiber is disposed within the conductive former, and wherein the conductive former comprises a cooling channel.

In some embodiments, the HTS tape stack is coupled to a conductive former and the optical fiber is coupled to the conductive former.

In some embodiments, the plurality of optical gratings are a plurality of fiber Bragg gratings (FBGs), and wherein the plurality of FBGs have respective center wavelengths linearly increasing along the length of the optical fiber.

In some embodiments, the HTS cable further comprises a conductive former having a central cooling channel, wherein the high-temperature superconductor comprises a plurality of HTS tape stacks disposed outwardly of the central cooling channel, wherein each of the plurality of optical fibers includes a plurality of optical gratings arranged such that center wavelengths of respective optical gratings of the plurality of optical gratings increase linearly along a length of the respective optical fiber.

In some embodiments, the HTS cable comprises a plurality of optical fibers disposed proximate a periphery of the conductive former including the optical fiber.

In some embodiments, the HTS cable comprises a plurality of optical fibers disposed proximate a periphery of the central cooling channel.

In some embodiments, the HTS cable further comprises a jacket surrounding the conductive former.

In some embodiments, the increase in center wavelength of the optical gratings along the length of the optical fiber is between approximately 0.01 nm and 10 nm per optical grating.

In some embodiments, the plurality of optical gratings are spaced at a density of at least one optical grating per 10 cm.

Some embodiments provide a high-temperature superconductor (HTS) cable, comprising: an elongated conductive former having a centrally located cooling channel and a plurality of HTS tape stack channels disposed at its periphery; a conductive jacket surrounding the elongated conductive former; a plurality of HTS tape stacks disposed in respective HTS tape stack channels of the plurality of HTS tape stack channels; and a plurality of optical fibers thermally coupled to the plurality of HTS tape stacks, each of at least two optical fibers of the plurality of optical fibers comprising a plurality of optical gratings of increasing center wavelength positioned along a length of the respective optical fiber.

In some embodiments, an optical fiber of the plurality of optical fibers is disposed at a periphery of the conductive jacket.

In some embodiments, an optical fiber of the plurality of optical fibers is disposed between an HTS tape stack of the plurality of HTS tape stacks and the centrally located cooling channel.

In some embodiments, the plurality of optical gratings of the at least two optical fibers of the plurality of optical fibers have center wavelengths that differ from neighboring optical gratings by between 0.01 nm and 10 nm.

In some embodiments, the plurality of HTS tape stacks includes four HTS tape stacks or five HTS tape stacks.

In some embodiments, the plurality of optical gratings of a first optical fiber of the at least two optical fibers forms a linear ramp structure.

In some embodiments, a first optical fiber of the plurality of optical fibers is configured to transmit light from a first end of the HTS cable to a second end of the HTS cable, and a second optical fiber of the plurality of optical fibers is configured to transmit light from the second end of the HTS cable to the first end of the HTS cable.

Some embodiments provide a quench detection system, comprising: a high-temperature-superconducting (HTS) cable comprising a superconductor and an optical fiber having a plurality of fiber Bragg gratings (FBGs) of different center wavelengths arranged along a length of the HTS cable such that the different center wavelengths increase along the length of the HTS cable; a light source coupled to an end of the HTS cable and configured to supply an optical input signal to the optical fiber; and an optical detector coupled to the end of the HTS cable and configured to receive a reflected optical signal from the optical fiber; and a processor configured to process the reflected optical signal at least in part by adjusting a slope of a spectrum exhibited by the reflected optical signal.

In some embodiments, the light source is configured to supply the optical input signal by sweeping through a plurality of wavelengths corresponding to the different center wavelengths of the plurality of FBGs.

In some embodiments, the light source is configured to supply the optical input signal by sweeping through wavelengths between 1500 nm and 1800 nm.

In some embodiments, the light source is configured to supply the optical input signal by generating broadband light.

In some embodiments, the light source is configured to generate broadband light having wavelengths in a range from 1500 nm to 1600 nm.

In some embodiments, the plurality of FBGs form a dense linear ramp.

In some embodiments, the FBGs of different center wavelengths are positioned such that their center wavelengths create a linear ramp.

Some embodiments provide a quench detection system, comprising: a high-temperature superconducting (HTS) cable comprising a superconductor and an optical fiber having a plurality of fiber Bragg gratings (FBGs) of different center wavelengths arranged along a length of the HTS cable such that the different center wavelengths increase along the length of the HTS cable; a light source coupled to an end of the HTS cable and configured to supply an optical input signal to the optical fiber; and an optical detector coupled to the end of the HTS cable and configured to receive a reflected optical signal from the optical fiber; and a processor configured to process the reflected optical signal at least in part by subtracting a fitted curve from a spectrum exhibited by the reflected optical signal.

In some embodiments, the processor is configured to subtract a fitted curve from the spectrum exhibited by the reflected optical signal at least in part by adjusting a slope of the spectrum exhibited by the reflected optical signal.

In some embodiments, the processor is configured to subtract a fitted curve from the spectrum exhibited by the reflected optical signal at least in part by determining edge wavelength values of the spectrum and subtracting the fitted curve from a region of the spectrum between the determined edge wavelength values.

In some embodiments, the processor is further configured to process the reflected optical signal at least in part by determining a change in value of the determined edge wavelength values over time.

Some embodiments provide a method of operating a quench detection system, comprising: applying an input optical signal to an optical fiber, the input optical signal including light having one or more wavelengths corresponding to wavelengths within a range of center wavelengths of optical gratings of the optical fiber; receiving a reflected signal spectrum from the optical fiber; determining a slope of the reflected signal spectrum; generating a compensation signal compensating the reflected signal spectrum; and applying the compensation signal to the reflected signal spectrum.

In some embodiments, applying the input optical signal comprises generating an optical signal having wavelengths that are swept through a range of the center wavelengths of the optical gratings of the optical fiber.

In some embodiments, applying the input optical signal comprises applying a broadband optical signal to the optical fiber.

In some embodiments, determining a slope of the reflected signal spectrum comprises determining edge values of the reflected signal spectrum and evaluating the slope of the reflected signal spectrum between the determined edge values.

In some embodiments, the method further comprises determining a change in value of the edge values over time.

Some embodiments provide a method of operating a quench detection system, comprising: applying an input optical signal to an optical fiber, the input optical signal including light having one or more wavelengths corresponding to wavelengths within a range of center wavelengths of optical gratings of the optical fiber; receiving a reflected signal spectrum from the optical fiber; generating a compensation signal using the received reflected signal spectrum; and applying the compensation signal to the reflected signal spectrum by subtracting a fitted curve from the reflected signal spectrum.

In some embodiments, applying the input optical signal comprises generating an optical signal having wavelengths that are swept through a range of the center wavelengths of the optical gratings of the optical fiber.

In some embodiments, applying the input optical signal comprises applying a broadband optical signal to the optical fiber.

In some embodiments, generating the compensation signal comprises generating the fitted curve using the reflected signal spectrum.

In some embodiments, generating the fitted curve comprises determining a slope of the reflected signal spectrum.

In some embodiments, determining the slope of the reflected signal spectrum comprises determining edge values of the reflected signal spectrum and determining the slope of the reflected signal spectrum between the determined edge values.

In some embodiments, determining a change in value of the edge values over time.

### BRIEF DESCRIPTION OF DRAWINGS

Various aspects and embodiments will be described with reference to the following exemplary and non-limiting figures. It should be appreciated that the figures are not necessarily drawn to scale. Items appearing in multiple figures are indicated by the same or a similar reference number in all the figures in which they appear.

FIG. 1 is a cross-sectional view of an example tokamak, according to some embodiments of the present disclosure.

FIG. 2 is a cross-sectional view of the central solenoid magnets of the tokamak of FIG. 1, including high-temperature-superconducting (HTS) cables, according to a non-limiting embodiment of the present disclosure.

FIG. 3 is a perspective view of the poloidal field magnets of the tokamak of FIG. 1, including HTS cables, according to a non-limiting embodiment of the present disclosure.

FIG. 4A is a perspective view of an HTS cable, according to a non-limiting embodiment of the present disclosure.

FIG. 4B is a cross-sectional view of the HTS cable of FIG. 4A, illustrating a plurality of optical fibers that may include a series of optical gratings.

FIG. 4C is a close-up view of a portion of the HTS cable of FIG. 4B.

FIG. 4D is a cross-sectional view of another example of an HTS cable, according to a non-limiting embodiment of the present disclosure.

FIG. 4E is a cross-sectional view of another example of an HTS cable, according to a non-limiting embodiment of the present disclosure.

FIG. 4F is a cross-sectional view of another example of an HTS cable, according to a non-limiting embodiment of the present disclosure.

FIG. 5 illustrates an optical fiber including a series of optical gratings of differing center wavelength, according to a non-limiting embodiment of the present disclosure.

FIG. 6 illustrates an example of a portion of an optical fiber having a fiber Bragg grating (FBG), according to a non-limiting embodiment of the present disclosure.

FIG. 7 is a plot of the center wavelength by FBG for a series of FBGs of a HTS cable, according to a non-limiting embodiment of the present disclosure.

FIG. 8 illustrates a characteristic spectrum associated with reflection of light from a series of FBGs forming a dense linear ramp of center wavelengths, according to a non-limiting embodiment of the present disclosure.

FIG. 9 illustrates characteristic spectra associated with different states of radiation-induced attenuation (RIA) for an optical fiber having a dense linear ramp of FBGs.

FIG. 10 is a flowchart of a method of processing a signal reflected from a dense linear ramp of optical gratings (e.g., FBGs), according to a non-limiting embodiment of the present disclosure.

FIG. 11 is a flowchart illustrating a method of operating a HTS cable in an environment in which quench may occur, according to a non-limiting embodiment of the present disclosure.

FIG. 12 is a flowchart illustrating a method of operating a fusion energy device according to a non-limiting embodiment of the present disclosure.

FIG. 13 illustrates a system including a HTS cable having an optical fiber coupled to control circuitry, the optical fiber including a series of optical gratings of differing center wavelength, according to a non-limiting embodiment of the present disclosure.

FIG. 14A illustrates quench detection temperatures for a number of simulated quench events, according to a non-limiting embodiment of the present disclosure.

FIG. 14B is a plot of average detection time as a function of distance between an initiation site of a simulated quench event and an optical fiber, according to a non-limiting embodiment of the present disclosure.

FIG. 14C illustrates rates of change of temperature as a function of detection temperature for a number of simulated quench events, according to a non-limiting embodiment of the present disclosure.

FIG. 15A is a plot of a quench detection signal and optical fiber temperature over time, according to a non-limiting embodiment of the present disclosure.

FIG. 15B illustrates detected wavelengths as a function of time during the quench event of FIG. 15A, according to a non-limiting embodiment of the present disclosure.

FIG. 16 is a schematic diagram of an illustrative computing device, in accordance with some embodiments of the present disclosure.

### DETAILED DESCRIPTION

Aspects of the present disclosure provide methods and apparatuses for detecting quench in superconducting cables such as those that may be used in magnetic fusion energy devices (e.g., tokamaks), particle accelerators, or other large scale, high-power devices that may experience ionizing radiation. Quench is an abrupt, localized transition of a superconducting structure to a non-superconducting (resistive) state. In some instances, quench can be highly detrimental to device operation and long-term device health. For example, uncontrolled quench can cause undesirable damage to a device. Early and accurate detection of quench allows for preventative or corrective action to be taken. Aspects of the present disclosure provide high-temperature-superconducting (HTS) cables implementing fiber optic quench detection. A fiber optic quench detector according to some aspects of the present disclosure includes one or more optical fibers, one or more of which have a series of optical gratings of differing center wavelength forming a dense linear ramp. In some embodiments, the optical gratings are fiber Bragg gratings (FBGs).

Magnetic fusion energy devices (e.g., tokamaks), particle accelerators, and other large-scale, high-power devices may use long HTS cables to generate magnetic fields. Such devices often require sufficient electrical current to generate high magnetic field strength over relatively large areas (e.g., tens of square meters or more). The use of superconducting magnets facilitates creation of the needed magnetic fields, including magnetic fields of the needed strength. The superconducting magnets utilize HTS cables to carry field-generating electrical current. Such HTS cables can be tens of meters or hundreds of meters long.

Temperature sensors can be used to monitor temperature along an HTS cable to detect quench. Quench of an HTS cable including a non-superconducting component can occur when the temperature of the superconductor rises above its current sharing temperature, which is the temperature at which current may begin to pass through the non-superconducting component(s) of the HTS cable. The current sharing temperature is sometimes lower than the critical temperature of the HTS cable. Positioning temperature sensors along the HTS cable allows for detection of temperature increases indicative of a potential quench event.

The temperature sensors are positioned sufficiently close together to provide a desired spatial resolution for the temperature monitoring. Since quench can occur at any point along the length of an HTS cable, it is desirable to monitor the temperature at enough points along the HTS cable to provide for rapid detection of quench. For example, in the context of a tokamak, it may be desirable to provide temperature monitoring every 20 cm along the length of the HTS cable, every 10 cm along the length of the HTS cable, every 5 cm along the length of the HTS cable, between every 5 cm and 50 cm along the length of the HTS cable, or at any resolution within that range.

Optical gratings, such as FBGs, may be used as temperature and mechanical strain detectors to detect quench in a superconducting cable by providing a temperature-and-strain-dependent reflected signal. Optical gratings are beneficial in this respect as they are immune to various environmental conditions that can negatively impact electrical, voltage-based temperature sensors, such as the strong magnetic fields present in a magnetic fusion energy device. When light impacts an FBG, a portion of the light is transmitted, and a portion is reflected in the direction from which the light was incident. The reflected signal (reflectivity as a function of wavelength) often presents as a narrow bandwidth spectrum, the center wavelength of which is temperature and strain dependent. By monitoring the center wavelength of the signal reflected by the optical grating to detect shifts, as well as the magnitude, temperature and/or strain changes may be detected. Namely, a shift in the center wavelength of the reflected signal and/or a change in the magnitude of the center wavelength of the reflected signal may indicate a temperature change.

The inventors have appreciated that the reflected and transmitted spectra from the optical gratings of an optical fiber are susceptible to radiation-induced attenuation (RIA), independent of changes in temperature or strain, which can impede the ability to detect temperature changes along an HTS cable using a series of optical gratings. Ionizing radiation commonly occurs in tokamaks, particle accelerators, and other large scale, high-power devices that use strong magnetic and/or electric fields. Such ionizing radiation can cause defects in the optical fiber, resulting in either permanent or transient RIA of the optical signal depending on the radiation dosage. Sufficiently high dosages can result in permanent defects to the optical fiber which in turn manifests as permanent RIA. Transient RIA results from sufficiently high radiation dosage rates but can be repaired via thermal or optical annealing. RIA, including transient RIA, may be indistinguishable from temperature-and/or strain-induced changes in the reflected spectral signal, particularly if there is no correlation between the center wavelength of the optical grating and its positioning along the length of the optical fiber.

The inventors have further appreciated that the degree of attenuation of a signal reflected from an optical grating of an optical fiber is dependent on the distance of the grating from the detection point. The amount of attenuation increases with distance from the detection point. For example, light reflected from an optical grating positioned farther from the input end of the optical fiber will experience greater transient RIA than light reflected from an optical grating positioned closer to the input end of the optical fiber. Additionally, attenuation inherent in the FBGs and losses in the optical fiber itself also increase along the length of the fiber and can be compensated for in a similar manner.

The inventors have appreciated that arranging a series of optical gratings (e.g., FBGs) of different center wavelengths along an optical fiber of an HTS cable in a dense, linear ramp allows for compensation of transient RIA in the reflected spectrum. The series of optical gratings may be dense in the sense that the center wavelengths are sufficiently close to each other to cause the individual reflected spectra to overlap, thus being indistinguishable and forming a continuous spectrum. For example, the respective center wavelengths may differ from center wavelengths of nearest neighbor optical gratings by less than a full width at half max (FWHM) spectral response (with respect to reflectivity as a function of wavelength) of the individual optical gratings. With such spacing, the individual reflected spectra may overlap to the point of being indistinguishable. Arranging the series of optical gratings such that the center wavelengths increase linearly along the length of the HTS cable-thus representing a “linear ramp”—has the effect that distance-dependent, transient RIA will have a linear, or substantially linear, impact on the resulting spectrum of reflectivity as a function of wavelength from the series of optical gratings. In this configuration, transient RIA will cause a downward (e.g., negative) slope of the reflected spectrum. The slope of the spectrum representing reflectivity as a function of wavelength can be determined, and the effect of the transient RIA compensated by applying a suitable compensation factor, such as a reflectivity value or function, to the spectrum.

According to an aspect of the present disclosure, a HTS cable comprises one or more optical fibers having a series of optical gratings of different center wavelengths arranged in a dense, linear ramp. The optical gratings may be FBGs. The optical gratings may have center wavelengths increasing by between 50 picometers and 150 picometers (e.g., 80 picometers) per FBG. The total increase in center wavelength may be between 50 nm and 200 nm in some embodiments, with optical gratings spaced between 5 cm and 20 cm from their nearest neighbors in some embodiments, and between 2 cm and 20 cm in some embodiments, including any value within those ranges. In one non-limiting example, an input light source may be coupled to one end of the optical fiber and configured to input light sweeping through a wavelength range covering the range of center wavelengths of the optical gratings along the optical fiber. In another non-limiting example, the input light source may be configured to generate a broadband optical signal (e.g., comprising multiple wavelengths of light, comprising “white” light). An optical detector may be coupled to the optical fiber to detect the reflected spectrum from the plurality of optical gratings. A processor may be configured to process the received spectrum, determine an attenuation of the reflected spectrum resulting from transient RIA, and to apply a compensation, such as a compensation value or a compensation function. The reflected spectrum may further be used to monitor for temperature and/or strain variations along the length of the HTS cable.

According to an aspect of the present disclosure, a method is provided of operating a HTS cable including an optical fiber having a plurality of optical gratings (e.g., FBGs) of linearly increasing center wavelength positioned along its length. The center wavelengths may be densely spaced, so that the resulting spectra from the various optical gratings may be largely indistinguishable. The method comprises applying an input optical signal to the optical fiber of the HTS cable, detecting a response spectrum, and compensating the response spectrum, for example by adjusting a slope of the response spectrum. The response spectrum is monitored for temperature-induced or strain-induced changes.

According to an aspect of the present application, a method is provided for detecting quench in a superconducting cable having a plurality of FBGs of linearly increasing center wavelength spaced along the length of the superconducting cable such that reflected spectra from the FBGs overlap. The method comprises analyzing a slope of the reflected spectrum from the plurality of FBGs, fitting a curve to the slope to determine a compensation signal, and applying the compensation signal to the reflected spectrum. The reflected spectrum is monitored for temperature-induced or strain-induced changes.

According to an aspect of the present disclosure, compensation of transient RIA of a reflection signal from a plurality of FBGs of an optical fiber is used in combination with one or more techniques for preventing such attenuation. For example, optical annealing may be used to reduce or eliminate transient RIA. Combining prevention techniques and compensation techniques may provide an enhanced reduction in RIA, thus providing enhanced quench detection in a tokamak or other high-power device utilizing HTS cables.

As used herein the phrases “HTS materials” or “HTS superconductors” refer to superconducting materials having a critical temperature above 30° K. at zero self-field.

The aspects and embodiments described above, as well as additional aspects and embodiments, are described further below. These aspects and/or embodiments may be used individually, all together, or in any combination of two or more, as the disclosure is not limited in this respect.

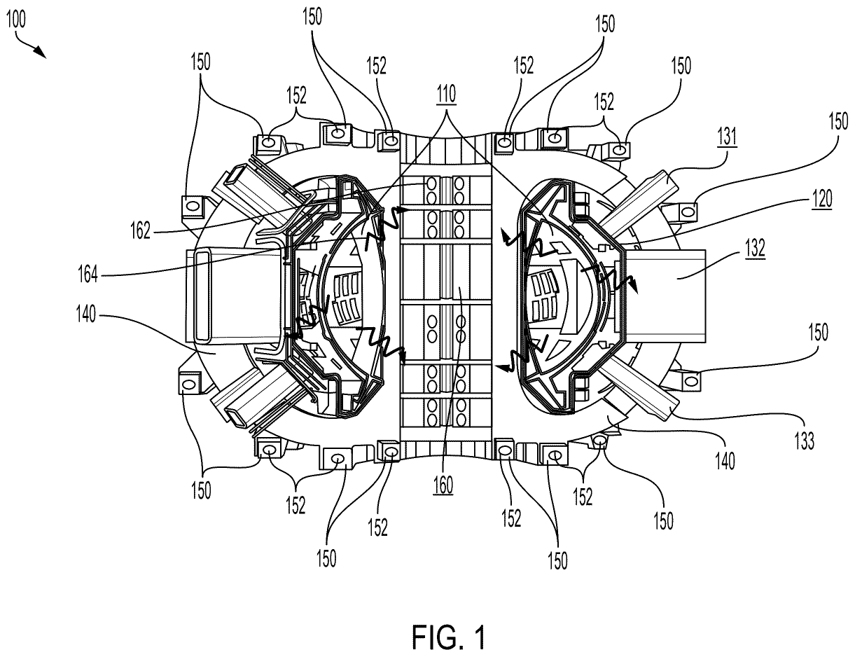

As described above, aspects of the present disclosure provide methods and apparatuses for detecting quench in superconducting cables such as those that may be used in magnetic fusion energy devices (e.g., tokamaks), particle accelerators, or other high-power devices. FIG. 1 depicts a cross-sectional view of an example tokamak (or, more generally, a fusion energy device), according to some embodiments of the present disclosure. As shown in FIG. 1, tokamak 100 generates a core plasma 110 that circulates within a vacuum vessel 120, which is shaped as a toroid. There are numerous ports integrally formed within, or otherwise coupled to, the vacuum vessel that provide access to the vacuum vessel from outside of the tokamak 100, including upper off-midplane ports 131, midplane ports 132, and lower off-midplane ports 133, which are situated at various points around the tokamak 100.

The tokamak 100 also includes a plurality of toroidal field (TF) magnets 140, a plurality of poloidal field (PF) magnets 150, and one or more central solenoid (CS) magnets 160. The TF magnets 140 are D-shaped (or approximately D-shaped) magnets that are configured to confine the core plasma 110 in a desired region of the vacuum vessel 120, and to generate flux within the core plasma. The PF magnets 150 are roughly ring-shaped magnets that are configured to shape and position the core plasma 110. The CS magnet(s) 160 are arranged in the center of the tokamak 100 and are configured to inductively drive the electrical current in the plasma.

Although not shown in FIG. 1, the TF magnet 140 includes one or more conductor windings within the housing. According to some embodiments, these conductors may include a high temperature superconductor, such as REBCO. In some embodiments, the TF magnet 140 may be configured to be cooled to around 8K during operation of the tokamak. However, this is an example, and the TF magnet 140 may be cooled to different temperatures.

TF magnet 140 may assume various potential forms. According to some embodiments, a TF magnet 140 may comprise a plurality of plates and one or more cooling channels. For example, the TF magnet 140 may include a plurality of plates arranged in a stack that includes a first plate, the first plate comprising a conducting channel on a first side of the first plate, at least part of the conducting channel being arranged in a spiral path, the conducting channel comprising a (HTS) material and a conductive material, and a plurality of cooling channels on a second side of the first plate, the second side opposing the first side.

According to some embodiments, a TF magnet 140 may comprise a winding of a non-insulated conductor, the conductor comprising a stack of HTS tapes, wherein each of the HTS tapes comprises an HTS material and is clad in a conductive material, a co-conductor layer, and a layer of solder arranged between and in contact with the stack of HTS tapes and the co-conductor layer.

According to some embodiments, a TF magnet 140 may comprise a winding of a non-insulated conductor, the conductor comprising a stack of HTS tapes, wherein each of the HTS tapes comprises a superconductor layer and is clad in a conductive material, wherein a ratio between a cross-sectional area of the conductive material and a cross-sectional area of the superconductor layer is at least 0.75.

According to some embodiments, a TF magnet may comprise a winding of a non-insulated conductor, the conductor comprising a stack of HTS tapes, wherein each of the HTS tapes comprises an HTS material and is clad in a conductive material, and a stack of conductive non-superconductor tapes arranged in contact with the stack of HTS tapes.

According to some embodiments, a TF magnet may comprise a winding of a non-insulated conductor, the conductor comprising a stack of high temperature superconductor (HTS) tapes, wherein each of the HTS tapes comprises an HTS material having a conductive material disposed over at least a portion thereof, a co-conductor layer arranged over the stack of HTS tapes, and solder disposed between and in electrical contact with the stack of HTS tapes and the co-conductor layer.

According to some embodiments, the on-axis toroidal magnetic field produced by the plurality of TF magnets 140 in the tokamak 100 may be greater than or equal to 8 Tesla (T), 9 T, 10 T, 11 T, 12 T or 13 T. According to some embodiments, the on-axis toroidal magnetic field produced by the plurality of TF magnets 140 in the tokamak 100 may be less than or equal to 15 T, 14 T, 13 T, 12 T, 11 T, or 10 T. Any suitable combination of the above ranges is also possible (e.g., an on-axis toroidal field of greater than or equal to 10 T and less than or equal to 15 T, or greater than or equal to 12 T and less than or equal to 13 T).

The PF magnets 150 and CS magnets 160 are superconducting magnets and include HTS cables. In FIG. 1, the HTS cables are illustrated in end-on view. PF magnets 150 include HTS cables 152 and CS magnets 160 include HTS cables 162. Further details of the HTS cables are illustrated in subsequent figures and described in further detail below. FIG. 1 illustrates a single HTS cable 152 per PF magnet 150 and a single layer (in the radial direction) of HTS cables 162 per CS magnet 160. The various aspects of the present disclosure are not limited in this respect. Any suitable number of HTS cables may be included in the PF magnets 150 and CS magnets 160. Optionally, the TF magnets 140 include HTS cables of the types described herein.

In some embodiments, the tokamak 100 may comprise, or may otherwise be coupled to, a source of auxiliary heating to bring the core plasma 110 to a desired temperature. In some embodiments, the auxiliary heating source may comprise an ion cyclotron resonance heating system (e.g., a 25 MW, 120 MHz heating system). Other auxiliary heating may include alpha particles produced during fusion, and/or ohmic power, which together may produce around 1 MW of further heating. In some embodiments, the tokamak 100 may comprise a glow discharge cleaning system.

During operation of the tokamak 100, an axisymmetric toroidal core plasma 110 is produced in the vacuum vessel 120. This plasma carries a toroidal electrical current, which in turn creates a poloidal magnetic field, providing confinement of the core plasma 110. The toroidal field magnets 140 provide stability to the electrical current in the core plasma 110, with the PF magnets 150 and the CS magnets 160 shaping and controlling the position of the core plasma 110. The core plasma 110 may be heated by the central solenoid, radio frequency (RF) and/or high energy neutron beams to initiate fusion. The resulting energy from the resulting neutrons may be captured in a blanket.

The tokamak 100 may generate radiation in various ways. Radiation 164 is shown in simplified form by the arrows emitted by the core plasma 110. The radiation 164 may irradiate the cables 152 and/or the cables 162, among other components of the tokamak 100.

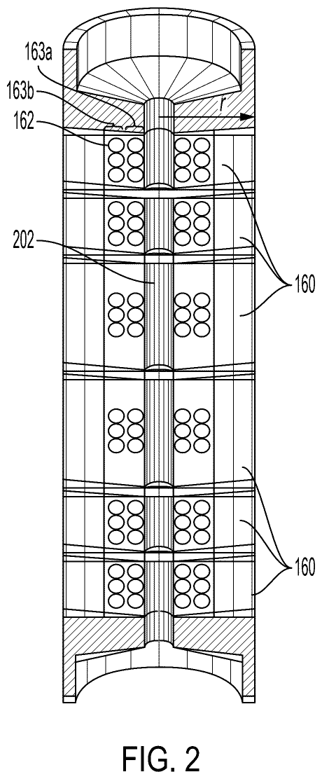

FIG. 2 depicts a cross-sectional perspective view of central solenoid (CS) magnets 160, according to some embodiments. The tokamak 100 may include any number of CS magnets 160 stacked in a column at or approximate to a central axis of the tokamak 100, such as between four (4) and eight (8) CS magnets (e.g., six CS magnets 160). The CS magnets 160 are configured to inductively drive the plasma current.

According to some embodiments, one or more of the CS magnets 160 may be formed from a HTS cable 162—shown in cross-section in FIG. 2—which may be wound around a central structure (e.g., a bobbin) 202 in one or more layers. For instance, a CS magnet may comprise multiple electrically insulated cable turns grouped in a multi-layer or multi-pancake arrangement. This allows the magnet to be driven in an alternating current (AC) mode by changing the power supply current over time, which in turn causes the field produced by the magnet to change over time as well. In the illustrated example, the HTS cable 162 has two layers 163a and 163b of windings in the radial direction r. However, a single layer of windings (e.g., 163a), or three or more layers of windings may be implemented in alternative embodiments, and the number of windings is not limited to that illustrated in FIG. 2.

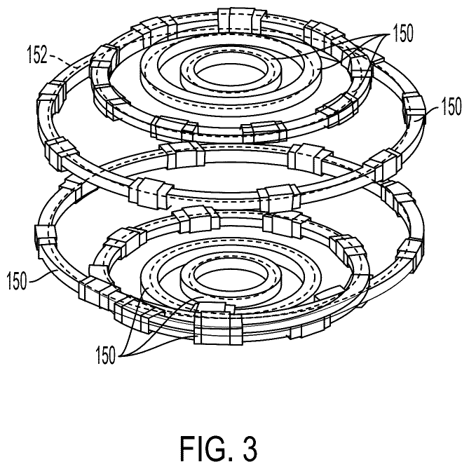

FIG. 3 depicts a perspective view of a set of poloidal field (PF) magnets 150 as included in the tokamak 100, according to some embodiments. The tokamak 100 may include any number of PF magnets 150 arranged proximate to the TF magnets 140. For instance, as shown the tokamak 100 may include four upper PF magnets and four lower PF magnets. The plurality of PF magnets 150 are configured to shape the core plasma in the vacuum vessel and maintain a desired position of the core plasma. According to some embodiments, one or more of the PF magnets 150 may be formed from a HTS cable 152 shown in dashed lines in FIG. 3 since they are within the illustrated PF magnets 150.

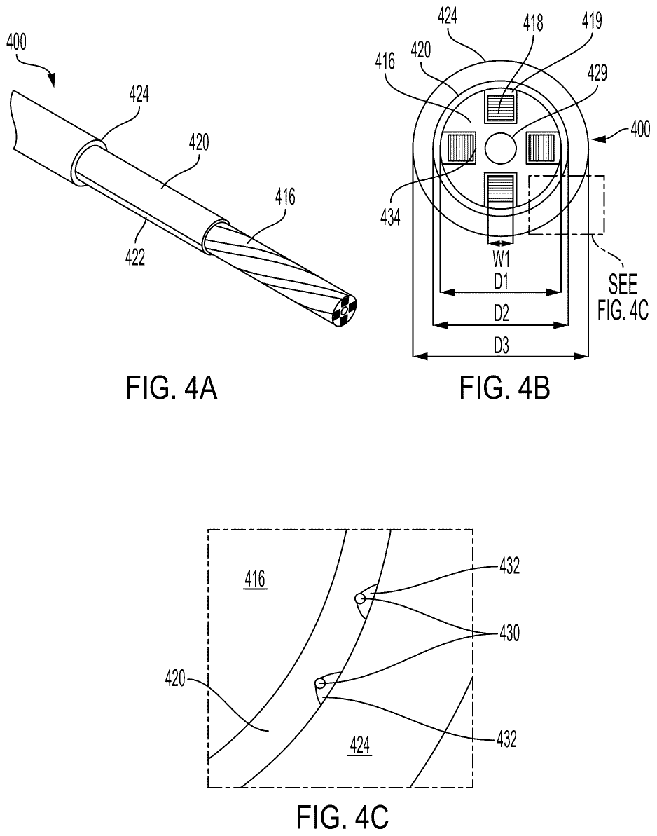

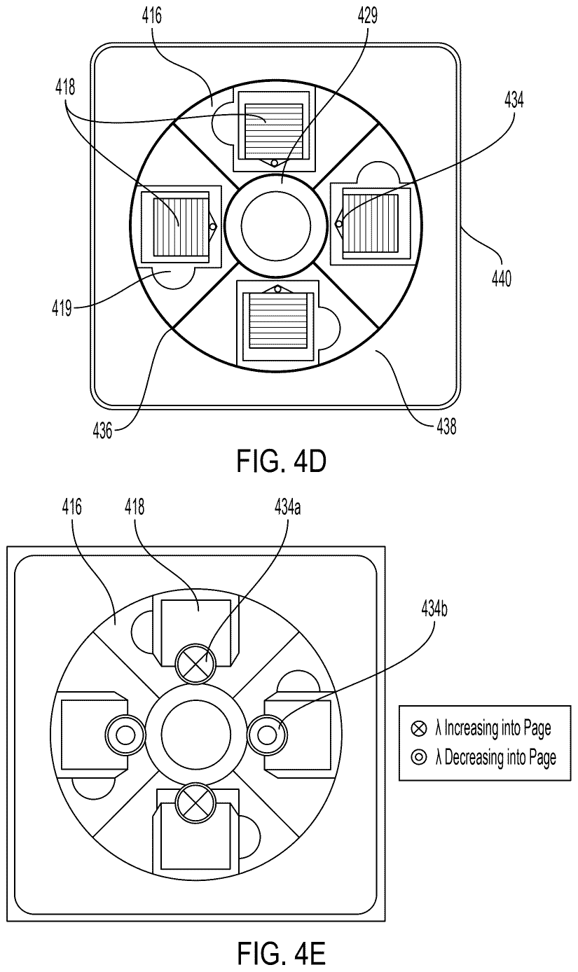

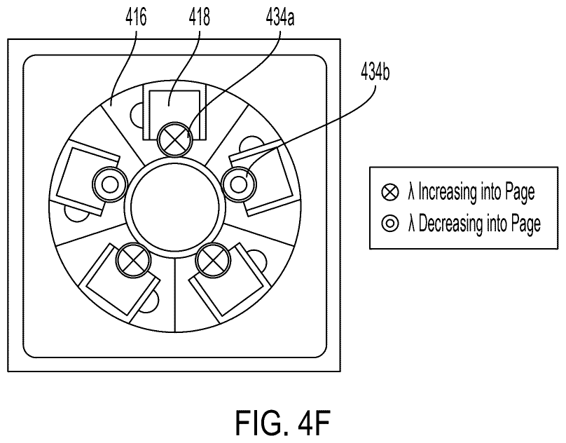

FIGS. 4A-4C illustrate a non-limiting example of an HTS cable 400 including optical fibers, and that may be used as the HTS cables for PF and/or CS magnets (e.g., PF magnets 150 and CS magnet 160) of a tokamak according to various embodiments of the present disclosure. More generally, the illustrated HTS cable 400 may be used in any of the types of devices described herein as utilizing HTS cables. As may be seen in FIGS. 4A and 4B, a HTS cable 400 includes a former 416 having HTS tape stacks 418 disposed in channels provided in an exterior surface of and extending along a length of the former 416. The former 416 may be made of any suitable electrically conductive material. In some embodiments, the former 416 may be formed of copper. The former 416 may be a single piece or may be segments (e.g., formed in thirds or quarters) with insulating material between them which may, for example, reduce eddy current formation in the former. The former 416 may have a cooling channel 429 through which coolant such as cryogen (not pictured) may flow to keep the temperature of the HTS cable lower than it would be otherwise.

The HTS cable 400 includes several additional features. HTS tape stacks 418 are held in their respective channels via solder 419. An inner jacket 420 (e.g., a copper jacket) is disposed around the former 416 and HTS tape stacks 418 and a plating 422 (e.g., a silver plating) may be disposed over the inner jacket 420. Although the entire surface of inner jacket 420 may be plated, in some embodiments, only a portion of inner jacket 420 may be plated. Thus, as illustrated in FIG. 4A, only about one-half of the surface of inner jacket 420 has a plating 422 disposed thereover. An outer jacket 424 (e.g., a steel or stainless-steel jacket) is disposed around inner jacket 420. In this example embodiment, the cable 400 has multiple channels in an electrically conductive (e.g., copper) former surrounded by one or more jackets. In some embodiments, the inner jacket 420 may comprise copper and the outer jacket 424 may comprise stainless steel. However, this is merely by way of example, as other suitable materials for the jackets and former may be used.

The illustrated components may have any suitable dimensions for carrying sufficient current to generate the desired magnetic field strengths, such as those magnetic field strengths listed previously herein. As shown in FIG. 4B, the width of an illustrative HTS tape stack 418 is W1, the diameter of the former 416 is D1, the diameter of the inner jacket 420 is D2, and the diameter of the outer jacket 424 is D3. The width of the channels in which the HTS tape stacks 418 fit may be substantially the same as the width of the HTS tape stacks themselves, being slightly larger to accommodate the HTS tape stacks. W1 may be between 2 mm and 5 mm in some embodiments. D3 may be between 25 mm and 35 mm. D2 is between D1 and D3, and D 1 is between W1 and D2.

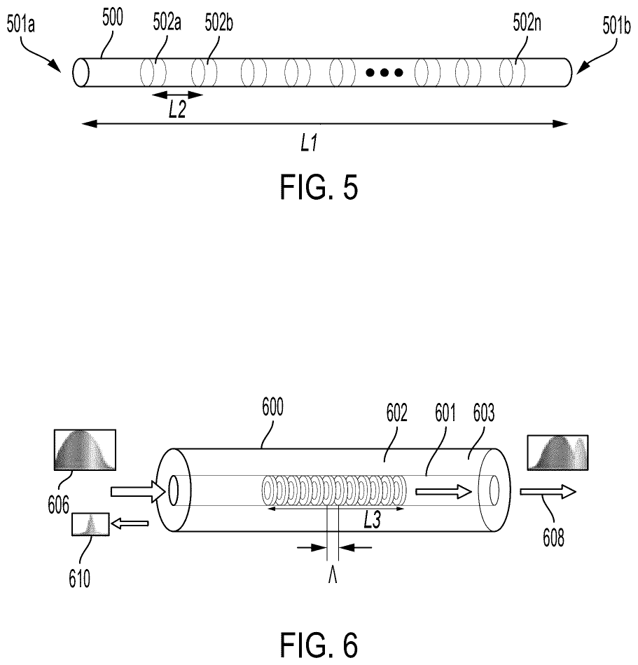

As shown in FIG. 4C, the HTS cable 400 comprises a plurality of optical fibers. Specifically, optical fibers 430 are disposed in grooves 432 in the inner jacket 420. In this illustration, two optical fibers 430 are shown. However, one or more optical fibers may be provided. Optical fiber 434 is also shown, with different positioning than that of optical fibers 430. The optical fiber 434 is disposed within a channel of the former 416. In some embodiments, several optical fibers may be included in the HTS cable 400. The optical fibers may be of the types described further herein, having a series of optical gratings (e.g., fiber Bragg gratings (FBGs)) of different center wavelengths. For example, the optical fibers 430 and 434 may be of the type illustrated in FIG. 5 and described further below.

The optical fibers of the HTS cable may be positioned in various ways with respect to other components of the HTS cable to provide a reflected signal that is indicative of temperature changes in the HTS tape stack and/or HTS cable more generally. In some embodiments, the optical fiber(s) may be in thermal contact with the HTS tape stack, for example being connected to the HTS tape stack(s) by thermally conductive material. In the example of FIGS. 4A-4C, the optical fibers 430 are disposed in the grooves 432 in the inner jacket 420. The optical fiber 434 is disposed within a channel of the former 416, as depicted in the example of FIG. 4D, such that the optical fiber 434 is disposed between the HTS tape stacks 418 and the cooling channel 429, and the optical fibers 434 are disposed around a periphery of the cooling channel 429. The positioning of optical fibers 430 and 434 may be alternatives, in that an HTS cable may utilizes one of the two illustrated positionings and not the other. In some embodiments, though, optical fibers may be disposed in both locations. Moreover, not all embodiments are limited to the illustrated positioning of optical fibers 430 and 434. The optical fibers may instead be disposed on another portion of the HTS cable.

The optical fibers of the HTS cable may be configured to transmit input light in multiple directions along the length of the HTS cable. In some embodiments, the optical fiber(s) may be configured to transmit input light in opposing directions, as shown in the examples of FIGS. 4E-4F. As depicted in the example of FIG. 4E, the optical fibers may include a first optical fiber 434a configured to transmit input light in a direction into the page (e.g., away from the viewer) and a second optical fiber 434b configured to transmit input light in a direction out of the page (e.g., towards the viewer). The first and second optical fibers 434a and 434b may be arranged in an alternating pattern, with first optical fibers 434a neighboring second optical fibers 434b, as depicted in the example of FIG. 4E. Alternatively, the first and second optical fibers 434a and 434b may be arranged in an unbalanced pattern such that a first optical fiber 434a may have another first optical fiber 434a as a nearest neighbor, as depicted in FIG. 4F. It should be appreciated that in some embodiments, second optical fibers 434b may alternatively have another second optical fiber 434b as a nearest neighbor, as aspects of the technology described herein are not limited in this respect.

FIG. 5 illustrates an optical fiber 500 that is an example implementation of the optical fiber 430 of FIG. 4B, including a series of optical gratings of differing center wavelength, according to a non-limiting embodiment of the present disclosure. As shown, the optical fiber 500 comprises a first end 501a and second end 501b, with the length LI being the distance between the two ends. The optical fiber 500 comprises a plurality of optical gratings 502a, 502b . . . 502n. The optical gratings are FBGs in some embodiments. The optical gratings 502a . . . 502n are separated by a distance L2.

The number and spacing of optical gratings 502a . . . 502n may be selected to provide sufficient detection of quench in the HTS cable in which the optical fiber is disposed. As described previously, embodiments of the present disclosure provide a series of optical gratings positioned along a HTS cable. The length LI may be tens of meters or hundreds of meters (e.g., between 20 meters and 700 meters, including any value or range of values within that range). The distance L2 representing the optical grating spacing may be selected to provide the desired measurement spatial resolution for detecting quench sufficiently quickly. As an example, it may be desired to provide a spatial resolution between 2 cm and 50 cm (e.g., 10 cm, 20 cm, or any value within that range), as described previously herein. Accordingly, the optical gratings 502a-502n may be spaced from their nearest neighbors by a distance L2 equal to any of those values. Thus, the number n of optical gratings may be in the tens, hundreds, or thousands. According to one specific, non-limiting example, L1 may be approximately 200 meters, n may be 2,000 (2,000 optical gratings), and L2 may be approximately 10 cm. As another non-limiting example, the HTS cable and its optical fiber has a length greater than 50 meters and the plurality of optical gratings are spaced at between 2 cm and 30 cm from nearest neighbor optical gratings.

The optical gratings 502a-502n may take various forms. In some embodiments, the optical gratings 502a . . . 502n are FBGs. FIG. 6 illustrates a non-limiting example of an FBG which may be used as for one or more of the optical gratings 502a-502n of FIG. 5.

As shown in FIG. 6, the optical fiber 600, which is a non-limiting example of an implementation of a portion of the optical fiber 500 of FIG. 5, includes multiple features. The optical fiber 600 comprises a core 601 and cladding 603. The core 601 may have an index of refraction of n₁ and the cladding 603 an index of refraction of n₂. The optical fiber further comprises an FBG 602 representing an optical grating. A single optical grating is shown for simplicity of illustration, although the number of optical gratings included in the optical fiber 600 may be any number explained above in connection with FIG. 5. The number of FBGs included will depend on the length of the optical fiber (and, therefore, the length of the HTS cable in which the optical fiber is disposed) and the desired spacing density to provide sufficiently rapid detection of quench along the HTS cable.

As shown in FIG. 6, the FBG 602 is characterized by a few parameters. The FBG 602 comprises a length L3 and a periodic variation in its refractive index, with grating period ∧. The FBG 602 may include alternating portions with indices of refraction of n1 (the same as the core 601) and n₃. The FBG 602 exhibits a center wavelength λ_{C}.

Input light 606 may be directed down the optical fiber 600 to the FBG 602. The FBG 602 may transmit some transmitted light 608 and reflect some reflected light 610. The reflected light 610 generally has a wavelength corresponding to the center wavelength λ_{C} of the FBG 602. As described previously herein, the center wavelength and magnitude of the reflected and transmitted light is temperature dependent. Also, the reflected light 610 and transmitted light 608 may be attenuated if the optical fiber 600 is exposed to ionizing radiation.

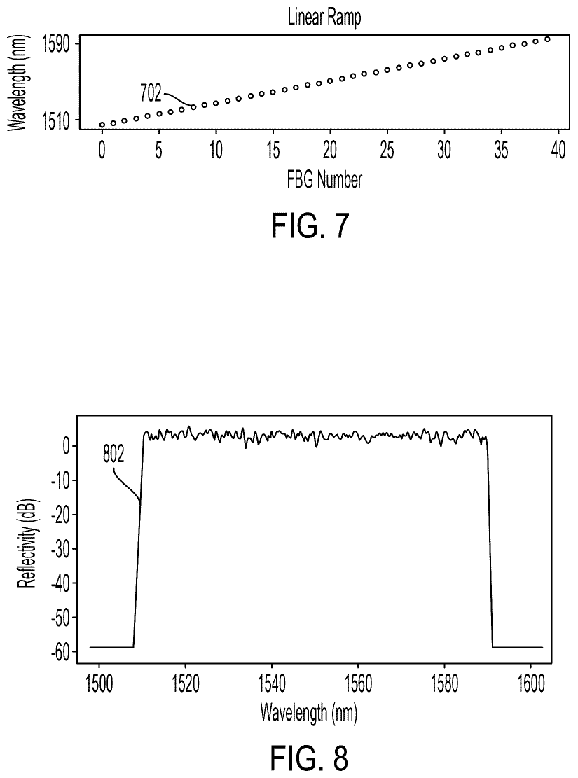

As explained above, in some embodiments of the present technology, a HTS cable includes one or more optical fibers with gratings (e.g., FBGs) having different center wavelengths and arranged such that the center wavelengths increase from one end of the optical fiber (and therefore one end of the HTS cable) to the other. In some embodiments, the increase is linear. FIG. 7 is a plot of the center wavelength by FBG for a series of FBGs of a HTS cable, according to a non-limiting embodiment of the present disclosure. The illustrated arrangement may represent an implementation of the gratings 502a-502n of FIG. 5. In the plot, the x-axis represents the FBG (1^{st} FBG, 2^{nd} FBG, 3^{rd} FBG, etc.), which are numbered from 0 to 39. In practice, hundreds or thousands of FBGs may be included along a fiber optical cable of an HTS cable that is tens or hundreds of meters long, as previously described. In FIG. 7, the y-axis represents the center wavelength. As shown in this example, the gratings have center wavelengths that increase linearly from the first end of the optical fiber (nearest the 1^{st} FBG) to the second end (nearest the last FBG). Specifically, in this example, the data 702 shows a center wavelength increasing from a low value of about 1510 nanometers to about 1590 nm. The increase is linear in this example, such that the data 702 exhibits a linear slope. A linear increase of this type may be referred to as a linear ramp.

The illustrated data 702 of FIG. 7 also represents a dense linear ramp. As shown, the center wavelengths of the FBGs differ from that of their nearest neighbors by about 2 nm. The full-width half-max (FWHM) of the reflected spectrum from each FBG in at least some embodiments is greater than the center wavelength spacing. In the example of FIG. 7, for instance, the FWHM of the reflected spectra from the FBGs may be greater than 2 nm. Therefore, since the center wavelength spacing of the neighboring FBGs is smaller than the FWHM, the individual reflected spectra from the FBGs will overlap, making them indistinguishable. In this sense, the illustrated FBG center wavelength spacing represents a dense arrangement. Given that the center wavelength spacing also increases linearly, FIG. 7 may be said to represent a dense linear ramp.

The inventors have appreciated that use of a dense linear ramp of optical grating center wavelengths may be beneficial for monitoring temperature and/or strain in an HTS cable. As explained previously herein, HTS cables in the types of devices described herein may be long, such as tens or hundreds of meters long, meaning that a large number of optical gratings may be needed to provide the desired spatial resolution. For example, tens, hundreds, or thousands of optical gratings may be needed. Generating a reflected signal from an optical grating of an HTS cable optical fiber involves exciting the optical grating with a wavelength of input light that overlaps with the center wavelength of the optical grating. Using a densely spaced series of center wavelengths of optical gratings facilitates generating the needed excitation light in a practical manner, since the input light source would need to generate a narrower sweep of excitation wavelengths than that required if the optical grating center wavelengths were not densely arranged. Moreover, by arranging the optical gratings on the optical fiber such that their center wavelengths increase linearly and, given that transient RIA increases the farther the optical grating is from the detection location, a simpler (e.g., linear) compensation may be used to account for transient RIA in the resulting reflected spectrum.

The center wavelength spacing illustrated in FIG. 7 is an example. Other spacings are possible while maintaining a dense arrangement. In some embodiments, the increase in center wavelength of the optical gratings along the length of the optical fiber is between approximately 0.01 nm and 10 nm per optical grating. Any value within that range, or any suitably dense pattern with monotonically increasing center wavelengths along the length of the optical fiber, may be used in certain embodiments while maintaining a dense ramp. As one non-limiting example, the optical fiber gratings may be disposed more densely at locations near joints or other areas more likely to experience quench, with the center wavelengths increasing monotonically as a function of distance along the length of the optical fiber. As another non-limiting example, the spacing between the optical fiber gratings may be a function of the expected quench propagation velocity (QPV), as affected by local conditions (e.g., temperature, magnetic field, etc.).

FIG. 8 illustrates characteristic spectra associated with reflection of light from a series of FBGs having center wavelengths arranged in a dense linear ramp, according to a non-limiting embodiment of the present disclosure. The illustrated plot 802 may represent data of reflected light from an optical fiber having the configuration of FIG. 5 with optical gratings having center wavelengths as illustrated in FIG. 7. The x-axis represents wavelength of the reflected light in nanometers (nm) and the y-axis represents the reflectively in dB. The plot may be generated by sweeping the input optical signal through a wavelength range encompassing the center wavelengths of all the optical fiber's optical gratings. In this example, for instance, the input signal to the optical fiber may be swept from 1500 nm to 1600 nm, and the reflective signal detected. As shown, there is substantially no reflected light below 1510 nm and above 1590 nm. Between those wavelengths, the reflectivity is substantially constant. In this example, the reflectivity is slightly above zero between 1510 nm and 1590 nm.

Notably, the peaks associated with each FBG are substantially indistinguishable from that of their neighboring FBGs. Instead of presenting as clearly delineated peaks associated with the different FBGs of different center wavelength, the reflected spectra for the various FBGs overlap and thus appear as a substantially continuous spectrum. Such behavior arises when the FBGs center wavelengths form a dense linear ramp as described above, for example in connection with FIG. 7. In the presence of local heating for a given FBG, the center wavelength of reflected light from the given FBG will shift to a higher wavelength in response to the local heating, resulting in a change to the overall reflection spectrum received from the optical fiber. This local change can be detected by monitoring the reflected spectra over time to monitor for lateral shifts in local portions of the spectra.

The reflected spectra will remain relatively constant when the HTS cable is not experiencing mechanical strain or temperature changes. An additional external factor that can alter the reflected spectra and may need to be compensated for to determine whether a quench event is occurring, is RIA. Plot 802 illustrated in FIG. 8 corresponds to a situation in which the HTS cable is not experiencing RIA. In such a situation, the reflectivity for the different wavelengths of light reflected by the different FBGs is substantially the same. That is, the response curve is substantially flat (e.g., having a slope of approximately zero).

The inventors have appreciated that pulsed ionization can also cause attenuation of the reflected signal from gratings in an optical fiber such as that shown in FIG. 5. Fusion energy devices, such as tokamaks, generate substantial pulsed radiation, such as radiation 164 illustrated in FIG. 1. Such radiation may impinge on the HTS cables and cause attenuation of the reflected signal from gratings (e.g., FBGs) in the optical fiber. Such attenuation may be mistaken for temperature-induced attenuation of the reflected signal.

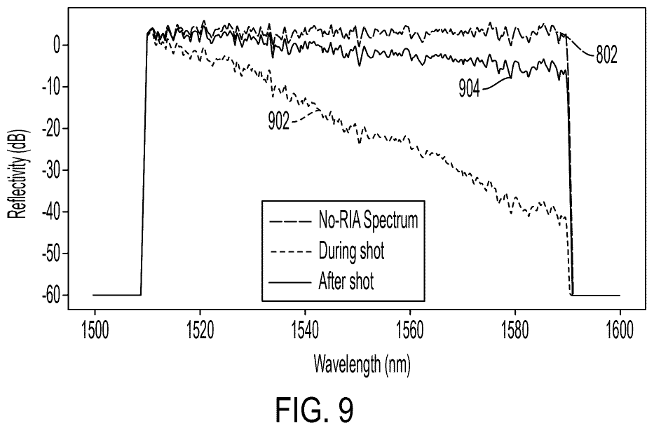

The inventors have further appreciated that ionization effects on reflected signals in a fiber optical cable are dependent on the distance of the optical grating from the light source, with increased distance corresponding to increased attenuation. Therefore, the impact on the reflected spectrum from a series of optical gratings forming a dense linear ramp will be a change in the slope of the reflected spectrum. A negative linear slope results in the presence of uniform radiation and constant optical power along the length of the fiber optical cable. Even with deviations from uniform radiation and/or constant optical power, a negative linear slope may be a suitable first order approximation of the change to the reflected spectra. FIG. 9 illustrates an example.

FIG. 9 illustrates three data sets. Plot 802 is the same as illustrated in FIG. 8 and explained in connection with that figure. Plot 902 and plot 904 represent the result of pulsed ionizing radiation impacting the HTS cable. Plot 902 represents the spectrum during the pulsed ionization event. Plot 904 represents the spectrum after the pulsed ionization event. Since the configuration of the HTS cable includes a linear ramp of FBGs, like that illustrated in FIG. 7, the attenuation will be greatest for the optical grating having a center wavelength of 1590 nm located further from the optical detector, next greatest for the optical grating having the next largest center wavelength located second further from the optical detector, and so on. This behavior results in the negatively sloped data shown by plots 902 and 904.

The impact of the ionization on the reflected spectrum can be compensated. The change in the spectrum can be determined, and the reflected data adjusted in a manner that compensates for the change. For example, in the context of FIG. 9, the slope of the spectra represented by plots 902 and 904 may be determined, and a compensation applied to effectively return the data to the form of plot 802. The compensation may be a linear compensation function. Use of a dense linear ramp of optical gratings provides the maximum correlation between distance and wavelength and may facilitate use of a linear compensation function to compensate for ionization-induced attenuation. In some embodiments, however, a polynomial compensation function may be applied instead of a linear compensation function, for example to take into account non-uniformities of radiation along the length of the cable.

The inventors have further appreciated that a dense reflection spectrum (e.g., as received from a densely arranged array of FBGs) is generally stable in the absence of changes in temperature and/or mechanical strain experienced by the optical fiber supporting the array of fiber gratings. Additionally, changes in temperature and/or strain that affect the entire optical fiber (e.g., changes in temperature and/or strain affecting the HTS cable uniformly) may present as a shift of the entire reflection spectrum with respect to wavelength. For example, in response to a uniform change in temperature and/or strain, edge wavelength values of the reflection spectrum may increase or decrease in value in a uniform manner (e.g., the reflection spectrum may shift to the left or right, but not change in width). This uniform movement of the reflection spectrum may be tracked (e.g., by tracking a centroid of the reflection spectrum) and used to compensate for such movement of the reflection spectrum.

The inventors have further appreciated that, in response to non-uniform applied strains, the edge wavelength values of the reflection spectrum may change in value in a non-uniform manner. For example, in response to a positive strain gradient applied to the optical fiber, the width of the reflection spectrum may increase (e.g., a lower edge wavelength value may decrease in value and an upper edge wavelength value may increase in value). Similarly, in response to a negative strain gradient applied to the optical fiber, the width of the reflection spectrum may decrease (e.g., a lower edge wavelength value may increase in value and an upper edge wavelength value may decrease in value). The width of the reflection spectrum may therefore be used to compensate for strain effects on the reflection spectrum.

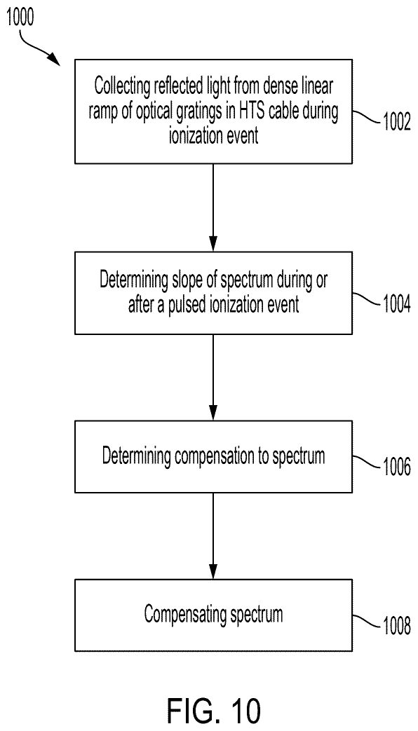

FIG. 10 is a flowchart of a method of processing a signal reflected from a dense linear ramp of optical gratings (e.g., FBGs), according to a non-limiting embodiment of the present disclosure. The method 1000 begins at stage 1002 with collecting reflected light from a dense linear ramp of optical gratings, such as FBGs, having differing center wavelengths that increase linearly. The collected reflected light represents a spectrum of reflectivity as a function of wavelength of the reflected light. The collection may occur periodically or substantially continuously during operation of the device which includes the HTS cable, such as a tokamak or other fusion energy device.

At stage 1004, a slope of the spectrum is determined during or after a pulsed ionization event to which the HTS cable is exposed. This determination may be made in the wavelength domain. The slope may be a negative slope when the linear ramp exhibits wavelengths that increase linearly as a function of distance along the fiber optical cable.

At stage 1006, the method comprises determining a compensation to the spectrum. The compensation may be a compensation value or a compensation function for application to the entire spectrum, such as a linear compensation signal or a polynomial compensation signal. The compensation may be a compensation for application to the reflectivity associated with one or more discrete wavelengths corresponding to the center wavelengths of one or more of the gratings of the fiber optical cable. In some embodiments, the compensation is a value or a linear function. In other embodiments, the compensation is a polynomial function.

In some embodiments, the compensation further comprises determining a change in value of edge wavelength values of the reflected spectrum over time. For example, the compensation may include determining a uniform shift of the edge wavelength values (e.g., a uniform increase or decrease of the edge wavelength values, as caused by a uniform strain applied to the HTS cable) and compensating for said uniform shift of the edge wavelength values. As another example, the compensation may include determining a non-uniform shift of the edge wavelength values (e.g., a widening or narrowing of the reflection spectrum, as may be caused by a non-uniform strain applied to the HTS cable) and compensating for said non-uniform shift of the edge wavelength values.

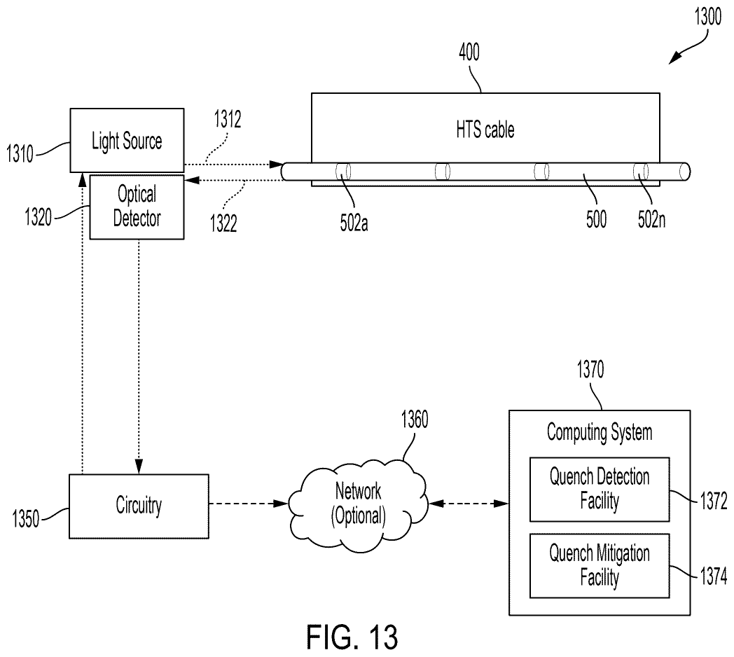

At stage 1008, the method comprises compensating the spectrum by applying the compensation determined in stage 1006. The compensation may be applied by a processing device, such as a controller or circuitry coupled to the HTS cable, examples of which are described further below in connection with FIG. 13. For example, the compensation may be a fitted curve fit to the slope of the reflected spectrum, and the processing device may compensate the reflected spectrum by subtracting the fitted curve from the reflected spectrum. In some embodiments, subtracting the fitted curve comprises adjusting a slope of the reflected spectrum. In some embodiments, the fitted curve may be fit to a slope of the reflected spectrum between edge wavelength values, and the fitted curve may be subtracted from a region of the reflected spectrum between the determined edge wavelength values.

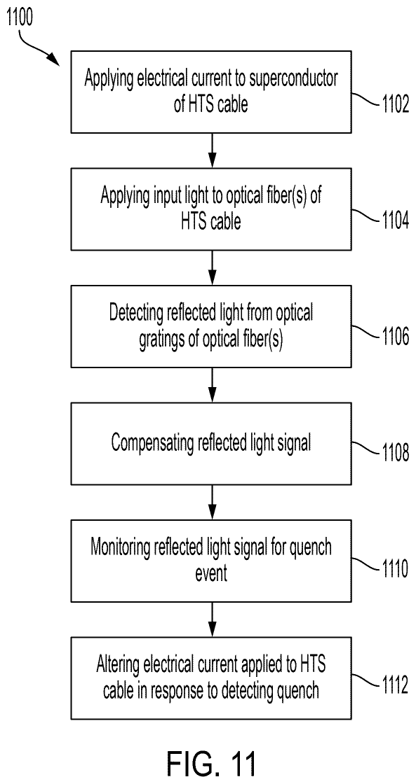

FIG. 11 is a flowchart illustrating a method of operating a HTS cable in an environment in which quench may occur. The order of steps illustrated is non-limiting, as some of the illustrated steps may be performed in parallel, or in a different order than shown.

The method 1100 begins at stage 1102 with applying an electrical current to the superconductor of an HTS cable. The HTS cable may include a superconductor, such as an HTS tape stack, and one or more optical fibers. For example, the HTS cable may be the type described with respect to FIGS. 4A-4C. The electrical current may be applied to the superconductor to generate a magnetic field, such as a poloidal magnetic field, central solenoid magnetic field, or other magnetic field in a fusion energy device such as a tokamak.

At stage 1104, the method comprises applying input light to an optical fiber of the HTS cable. This stage may operate in substantially the same manner as described above with respect to operation of the structures of FIGS. 5 and 6. The optical fiber may include a plurality of optical gratings (e.g., FBGs) forming a dense linear ramp of center wavelengths. The HTS cable may include multiple such optical fibers, and input light may be applied to one or more (e.g., each) of them at stage 1104. Applying the input light may comprise sweeping through wavelengths covering the range of wavelengths represented by the center wavelengths of the optical gratings of the optical fiber. Alternatively, applying the input light may comprise applying broadband light (e.g., “white” light) comprising light having wavelengths covering the range of wavelengths represented by the center wavelengths of the optical gratings of the optical fibers.

At stage 1106, the method comprises detecting the reflected light from the optical gratings of the optical fiber(s) to which the input light was applied at stage 1102. The reflected light may be detected using an optical detector such as a photodetector. The reflected light may represent a spectrum.

At stage 1108, the method comprises compensating the reflected light signal. Compensating the reflected light signal may involve applying compensation in the form of, for example, a compensation value or a compensation function. For example, a fitted curve may be subtracted from the spectrum exhibited by the reflected optical light. Stage 1108 may implement method 1000 of FIG. 10, described previously herein.

At stage 1110, the method comprises monitoring the reflected light signal for an indication of a quench event. As described previously herein, a quench event may be indicated by attenuation of the reflected light signal independent of RIA.

At stage 1112, the method comprises altering the electrical current applied to the HTS cable in response to detecting quench. For example, the electrical current may be reduced or stopped entirely.

As described above, the ordering of stages in FIG. 11 may be varied. Stage 1102 may be performed in parallel to stages 1104, 1106, 1108, and 1110. Other orderings of the stages are also possible.

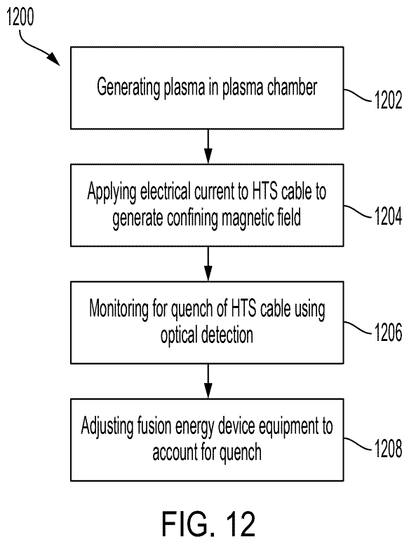

FIG. 12 is a flowchart illustrating a method of operating a fusion energy device. The fusion energy device may be a tokamak like that illustrated in FIG. 1. The method 1200 begins at stage 1202 with generating plasma in a plasma chamber. For example, the plasma may be a core plasma, like core plasma 110 of FIG. 1.

The method continues at stage 1204 with applying an electrical current to the HTS cable to generate a confining magnetic field for the plasma. Electrical current may be applied to one or more HTS cables for this purpose. For example, electrical current may be applied to HTS cables forming part of a PF magnet or CS magnet. The electrical current may be applied to a superconductor of the HTS cable(s), such as an HTS tape stack of the types described herein.

At stage 1206, the method comprises monitoring for quench of the HTS cable. Stage 1206 may be performed in the manner of stages 1104, 1106, 1108, and 1110 of FIG. 11.

At stage 1208, the method 1200 comprises adjusting the fusion energy device equipment to account for quench. For example, one or more components of the fusion energy device may be deactivated. Electrical current through an HTS cable in which quench is detected may be adjusted, as described above in connection with stage 1112 of FIG. 11. Other preventative or corrective action may be taken in addition to or alternatively to that illustrated.

Various embodiments have been described as utilizing a linear ramp configuration of optical gratings in a fiber optical cable of an HTS cable. Such a configuration allows for determining a linear and/or polynomial compensation function to be applied to the reflected light signal as described above. In alternative embodiments, the optical gratings of different center wavelengths are arranged in a configuration other than a linear ramp. In such alternative embodiments, the attenuation of the reflected signal resulting from radiation damage may not exhibit a linear slope, for example of the type illustrated in FIG. 9. Some other pattern of attenuation may appear in the reflected signal spectrum depending on the ordering of the optical gratings along the length of the optical fiber cable. In such situations, a different compensation (e.g., a different compensation function) may be applied to the reflected signal spectrum to compensate for the ionization. The nature of the compensation will depend on the positioning of the optical gratings along the fiber optical cable.

Various embodiments have been described as utilizing reflected light spectra from a plurality of optical gratings of an HTS cable to detect quench. In alternative embodiments the transmitted light may be analyzed for the same purpose. If transmitted light is to be used instead of reflected light, appropriate detection circuitry (e.g., a photodetector and processor) is coupled to the far end of the optical fiber cable opposite the end at which the light is input. In at least some embodiments, the ionization-induced attenuation of the transmitted light is detected and corrected.

The HTS cables and optical fibers described herein may be coupled to suitable control circuitry to control their operation in accordance with the various aspects described herein. FIG. 13 illustrates an example, showing a schematic diagram of an illustrative system 1300 to detect quench events in an HTS cable 400 of the types described in connection with FIGS. 4A-4F.

The system 1300 includes a light source 1310, optical detector 1320, an HTS cable 400, an optical fiber 500, circuitry 1350, optionally a network 1360, and a computing system 1370. It should be appreciated that system 1300 is illustrative and that a quench detection system may have one or more other components of any suitable type in addition to or instead of the components illustrated in FIG. 13. For example, there may be additional computing systems (e.g., two or more) present within a quench detection system. As another example, in some embodiments, the light source 1310, optical detector 1320, and/or circuitry 1350 may be combined into a single device (e.g., disposed in a single housing).

It should be appreciated that while the example of FIG. 13 shows a single optical fiber 520, aspects of the technology described herein are not limited in this respect, as described previously, for example, in connection with FIGS. 4A-4F. In some embodiments, there may be multiple optical fibers. For example, there may be a number of optical fibers in a range from 2 to 50, from 2 to 25, from 2 to 10, or from 2 to 7, or within any range within these ranges.

As illustrated in FIG. 13, system 1300 includes light source 1310 and optical detector 1320 optically coupled to the optical fiber 500. During operation of the system 1300, the light source 1310 may provide input light 1312 to the optical fiber 500. The light source may provide light that covers the center wavelength range of the optical gratings 502a-502n of the optical fiber 500. For example, the light source 1310 may include a broadband emitter that provides a broadband input signal or may sweep through a range of wavelengths covering the center wavelength range of the optical gratings 502a-502n. As described previously herein, having the gratings 502a-502n represent a dense linear ramp reduces the wavelength range needed for the input light (e.g., input light 1312) and therefore facilitates system design and operation. In some embodiments, the light source is configured to supply the optical input signal by sweeping through wavelengths between 1500 nm and 1800 nm, wavelengths between 1500 nm and 1700 nm, wavelengths between 1500 nm and 1600 nm, wavelengths between 1260 nm and 1360 nm, any ranges within those ranges, or any ranges of wavelengths from visible wavelengths to infrared wavelengths. The optical detector 1320 may detect the reflected light from the optical gratings 502a-502n. For example, the optical detector 1320 may be configured to detect a spectrum of the received light 1322, an intensity, and/or to determine a peak wavelength of the received light. In some embodiments, the optical detector 1320 may be an optical spectrum analyzer (OSA), an integrating sphere detector, a wavelength meter, or any other suitable optical detector. In some embodiments, the optical detector 1320 may be an interrogator configured to both send and receive light separate from the light generated by the light source 1310.

In some embodiments, the light source 1310 and optical detector 1320 may be coupled to circuitry 1350. Circuitry 1350 may be configured to determine a temperature of the superconductor of the HTS cable 400 based on the output of the optical detector 1320. For example, circuitry 1350 may be configured to receive an optical spectrum from the optical detector 1320, to determine a peak wavelength of the received optical spectrum, and to determine a temperature corresponding to that peak wavelength. Circuitry 1350 may be implemented using any suitable electronic circuitry, including but not limited to a field programmable gate array (FPGA), application specific integrated circuitry (ASIC), a microcontroller, and/or other microprocessing technologies. In some embodiments, circuitry 1350 may comprise or represent a microcontroller.

In some embodiments, the system 1300 includes computing system 1370 communicatively coupled to the circuitry 1350. The computing system 5130 may be any suitable electronic device configured to receive information from the circuitry 1350 and/or to process information received from the circuitry 1350. In some embodiments, the computing system 1370 may be a fixed electronic device such as a desktop computer, a rack-mounted computer, or any other suitable fixed electronic device. Alternatively, the computing system 1370 may be a portable device such as a laptop computer, a smart phone, a tablet computer, or any other portable device that may be configured to receive information from circuitry 1350 and/or to process information received from the circuitry 1350.

In some embodiments, the circuitry 1350 and the computing system 1370 may be communicatively connected by an optional network 1360. The network 1360 may be or include one or more local-and/or wide-area, wired and/or wireless networks, including a local-area or wide-area enterprise network and/or the Internet. Accordingly, the network 1360 may be, for example, a hard-wired network (e.g., a local area network within a facility), a wireless network (e.g., connected over Wi-Fi and/or cellular networks), a cloud-based computing network, or any combination thereof. For example, in some embodiments, the light source 1310, optical detector 1320, HTS cable 400, optical fiber 500, and the circuitry 1350 may be located within a same facility and connected directly to each other or connected to each other via the network 1360, while the computing system 1370 may be located in a remote facility and connected to the circuitry 1350 through the network 1360. It should be appreciated that in some embodiments, however, the computing system 1370 may be connected directly to the circuitry 1350 rather than being connected by the network 1360, as aspects of the technology described herein are not limited in this respect.

In some embodiments, the computing system 1370 may include a quench detection facility 1372. The quench detection facility 1372 may be configured to analyze data obtained by the optical detector 1320 and processed by circuitry 1350. The quench detection facility 1372 may be configured to, for example, analyze the temperature data output by circuitry 1350 to determine whether a quench event is about to occur and/or is presently occurring in the HTS cable 400. For example, the quench detection facility 1372 may be configured to determine whether the temperature data output by the circuitry 1350 is greater than a threshold temperature value and/or to fit a function to the temperature data over time to determine whether a thermal runaway event is about to occur and/or is presently occurring.

In some embodiments, the computing system 1370 may further include a quench mitigation facility 1374. The quench mitigation facility 1374 may be configured to generate instructions to cause the removal of energy from the HTS cable 400 in response to a determination by the quench detection facility 1372 of a quench event. For example, the quench mitigation facility 1374 may be configured to generate instructions to cause a removal of current flowing in the superconductor (e.g., HTS tape stack 418 of HTS cable 400) (e.g., by shunting or otherwise shorting the HTS tape stack) to remove energy stored in the HTS cable 400.

The quench detection facility 1372 and/or the quench mitigation facility 1374 may be implemented as hardware, software, or any suitable combination of hardware and software, as aspects of the technology described herein are not limited in this respect. As illustrated in FIG. 13, the quench detection facility 1372 and the quench mitigation facility 1374 may be implemented by the computing system 1370, such as by being implemented in software (e.g., executable instructions) executed by one or more processors of the computing system 1370. However, in other embodiments, the quench detection facility 1372 and/or the quench mitigation facility 1374 may be additionally or alternatively implemented at one or more other elements of the system 1300. For example, the quench detection facility 1372 and/or the quench mitigation facility 1374 may be implemented at the circuitry 1350. In other embodiments, the quench detection facility 1372 and/or the quench mitigation facility 1374 may be implemented at or with another device, such as a computing device located remotely from the system 1300 and receiving data via the network 1360.

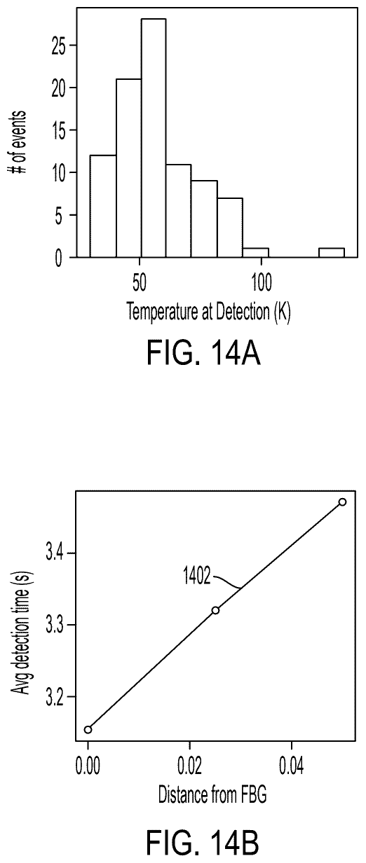

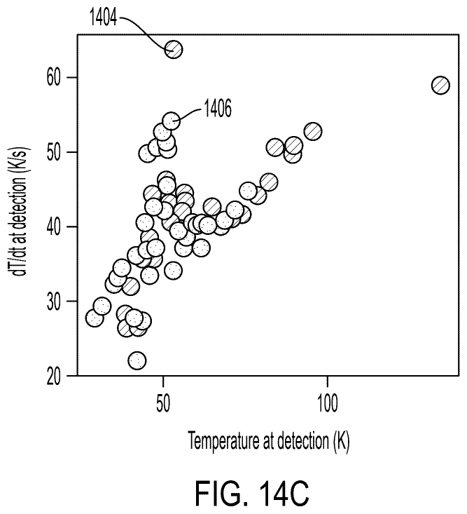

A quench detection system, such as system 1300 described herein, provides robust, reliable, and fast quench detection, thereby preventing and/or mitigating damage to components of the HTS cable or its environment. Aggregated results of simulations of reflected spectra from an illustrative quench detection system are shown in FIGS. 14A-14C, in accordance with some embodiments described herein. The simulations were implemented in python using a model of an array of FBGs bonded to copper and the transfer-matrix method to calculate responses of the arrays. The model includes effects of temperature and strain responses of the FBGs, and results from quench simulations and structural modeling are incorporated into the final simulated spectra. Additional aspects of the transfer-matrix method are described in “Multilayer optical calculations,” by S. J. Byrnes (Jan. 1, 2021; arXiv:1603.02720v5), which is incorporated herein by reference in its entirety.

Simulations of reflected spectra were obtained for quench events in optical fibers disposed at an inner diameter of a superconducting magnet formed by being layer wound, with each layer being radially larger than a previous layer. The simulations of reflected spectra were also obtained for optical fibers disposed at an outer diameter of a layer wound superconducting magnet. The simulated quench events were seeded at varying positions along the cable (e.g., 10, 10.025, 10.05, 50, 50.025, 50.05, 90, 90.025, and 90.05 m) and varying distances from an FBG (e.g., 0.025, 0.050 m).

As shown in FIG. 14A, all quench events were detected below a temperature of approximately 120 K, with a majority of quench events being detected below 75 K. Additionally, as shown by curve 1402 in FIG. 14B, average detection times were approximately between 3.1 and 3.5 seconds, with larger detection times occurring for quench events seeded further from an FBG. Finally, FIG. 14C shows the rate of change of the temperature at the time of quench detection as a function of the temperature at the time of detection for optical fibers arranged at the outer diameter of a layer wound superconducting magnet (data 1404) and for optical fibers arranged an inner diameter of a layer wound superconducting magnet (data 1406). As indicated by FIG. 14C, the average rate of change of the temperature for both optical fibers at the time of detection is between approximately 30-50 K/s, with data 1404 indicating some outlier data points having a higher rate of change or higher detection temperatures.

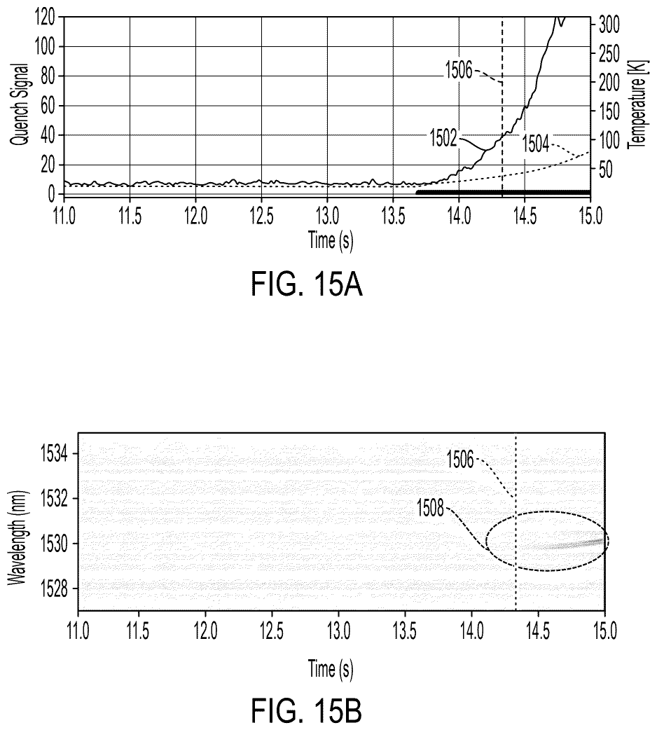

A single simulated reflection spectra 1502 and simulated temperature response 1504 are depicted in FIG. 15A. The dashed line 1506 indicates the time at which the quench event was detected. A corresponding spectral response is shown in FIG. 15B, clearly showing an optical response, within circle 1508, corresponding to the quench event simulated in FIG. 15A.

In some embodiments, the techniques described herein, such as those illustrated in FIGS. 10-12, may be embodied at least in part in computer-executable instructions implemented as software, including as application software, system software, firmware, middleware, embedded code, or any other suitable type of computer code. Such computer-executable instructions may be written using any of various suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application, for example as a software program application such as a quench detection facility.

Some exemplary functional facilities have been described herein for carrying out one or more tasks. It should be appreciated, though, that the functional facilities and division of tasks described is merely illustrative of the type of functional facilities that may implement the exemplary techniques described herein, and that embodiments are not limited to being implemented in any specific number, division, or type of functional facilities unless otherwise noted. In some implementations, all functionality may be implemented in a single functional facility. It should also be appreciated that, in some implementations, some of the functional facilities described herein may be implemented together with or separately from others, that is as a single unit or separate units.

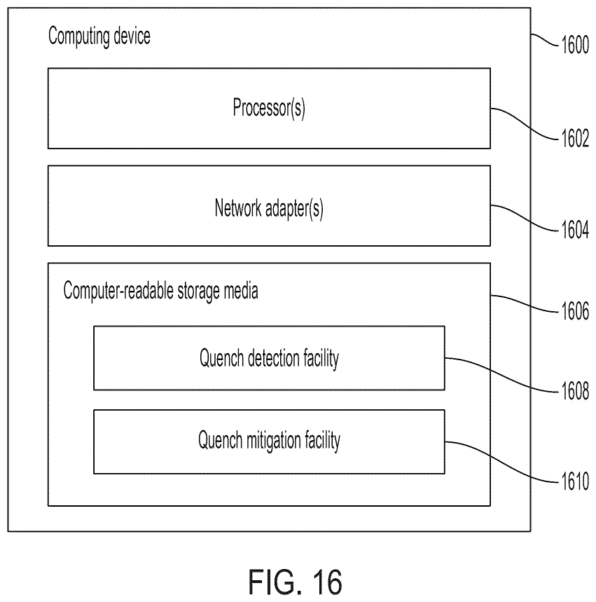

Computer-executable instructions implementing some of the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or nonpersistent solid-state memory (e.g., Flash memory, Magnetic RAM, etc.), or any other suitable storage media. Such a computer-readable medium may be implemented in any suitable manner, including as computer-readable storage media 1606 of FIG. 16 described below (e.g., as a portion of a computing device 1600) or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

In some, but not all, implementations in which the techniques described herein may be embodied as computer-executable instructions, these instructions may be executed on one or more suitable computing device(s) operating in any suitable computer system, including the exemplary computer system of FIG. 16, or one or more computing devices (or one or more processors of one or more computing devices) may be programmed to execute the computer-executable instructions. A computing device or processor may be programmed to execute instructions when the instructions are stored in a manner accessible to the computing device or processor, such as in a data store (e.g., an on-chip cache or instruction register, a computer-readable storage medium accessible via a bus, a computer-readable storage medium accessible via one or more networks and accessible by the device/processor, etc.). Functional facilities comprising these computer-executable instructions may be integrated with and direct the operation of a single multi-purpose programmable digital computing device, a coordinated system of two or more multi-purpose computing devices sharing processing power and jointly carrying out the techniques described herein, a single computing device or coordinated system of computing devices (co-located or geographically distributed) dedicated to executing the techniques described herein, one or more Field-Programmable Gate Arrays (FPGAs) for carrying out the techniques described herein, or any other suitable system.

FIG. 16 illustrates one exemplary implementation of a computing device in the form of a computing device 1600 that may be used in a system implementing techniques described herein, although others are possible. It should be appreciated that FIG. 16 is intended neither to be a depiction of necessary components for a computing device to operate as a quench detection system and/or a quench mitigation system in accordance with the principles described herein, nor a comprehensive depiction.

Computing device 1600 may comprise at least one processor 1602, a network adapter 1604, and computer-readable storage media 1606. Computing device 1600 may be, for example, a desktop or laptop personal computer, a personal digital assistant (PDA), a smart mobile phone, or any other suitable computing device. Network adapter 1604 may be any suitable hardware and/or software to enable the computing device 1600 to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable storage media 1606 may be adapted to store data to be processed and/or instructions to be executed by processor 1602. Processor 1602 provides for processing of data and execution of instructions. The data and instructions may be stored on the computer-readable storage media 1606.

The data and instructions stored on computer-readable storage media 1606 may comprise computer-executable instructions implementing techniques which operate according to the embodiments described herein. In the example of FIG. 16, computer-readable storage media 1606 stores computer-executable instructions implementing various facilities and storing various information as described above. Computer-readable storage media 1606 may store quench detection facility 1608 configured to derive information indicative of a quench event from fiber optic thermometry data and/or quench mitigation facility 1610 configured to cause the removal of stored energy from a superconducting material of an HTS cable in the event that a quench event is detected.

While not illustrated in FIG. 16, a computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

According to an aspect of the present disclosure, the methods and apparatus described herein for detecting quench in an HTS cable may be combined with techniques for photobleaching the optical fiber of the HTS cable. Permanent and transient radiation-induced attenuation (RIA) may be reduced or eliminated by annealing the optical fiber via the application of appropriate wavelengths of light. Such annealing may be performed to remove defects in the optical fiber caused by ionizing radiation. According to an aspect of the present disclosure, the optical fiber(s) of the HTS cable is annealed one or more times using annealing light, and transient RIA is compensated in any reflected light signal during operation of the optical fiber using the methods and apparatus described herein.

Various aspects of the present disclosure may be used alone, in combination, or in a variety of arrangements not specifically described in the embodiments described in the foregoing and is therefore not limited in its disclosure to the details and arrangement of components set forth in the foregoing description or illustrated in the drawings. For example, aspects described in one embodiment may be combined in any manner with aspects described in other embodiments.

The various aspects of the present disclosure provide various benefits, some examples of which have been described and are again listed now. Not all embodiments necessarily provide all listed benefits, and benefits other than those listed may be provided. Aspects of the present disclosure allow for detecting rapid, localized, anomalous temperature deviations in high-temperature superconducting (HTS) cables which could indicate a catastrophic cascading quench, or any other systematic failure. Thus, safe and regular operation of these superconducting magnets may be facilitated. Triggering associated protection systems can prevent irreparable damage to the HTS cable and HTS tape of the cable. Some aspects provide a practical, distributed optical temperature monitor suitable for use on long HTS cables in environments characterized by high magnetic field strength and strong ionizing radiation. Some aspects provide systems and techniques for maximally limiting the effect of transient RIA on the optical signal of a distributed optical temperature sensing system. Also, use of a dense linear ramp pattern as described herein allows for approximate localization of thermal fluctuations along the HTS cable. Further, the system and technique are readily scalable to use any length of optical fiber with the same measurement and processing infrastructure, although with decreasing sensitivity for longer sensing lengths.

Beyond detecting quench, the system and techniques described herein may be used generally for temperature and/or strain sensing, particularly in environments subject to high doses of ionizing radiation.

The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having described above several aspects of at least one embodiment, it is to be appreciated various alterations, modifications, and improvements will readily occur to those skilled in the art. Such alterations, modifications, and improvements are intended to be object of this disclosure. Accordingly, the foregoing description and drawings are by way of example only.

1. A high-temperature-superconducting (HTS) cable, comprising:
a high-temperature superconductor; and
an optical fiber thermally coupled to the high-temperature superconductor and comprising a plurality of optical gratings having respective center wavelengths, wherein:
the respective center wavelengths increase along a length of the HTS cable, and
the respective center wavelengths differ from center wavelengths of nearest neighbor optical gratings by less than a full width at half max spectral response of the optical gratings.

2. The HTS cable of claim 1, wherein optical gratings of the plurality of optical gratings are arranged along the optical fiber such that respective center wavelengths of the optical gratings increase linearly along the length of the optical fiber.

3. The HTS cable of claim 1, wherein the optical fiber has a length greater than 50 meters and the plurality of optical gratings are spaced from nearest neighbor optical gratings by a distance in a range from 2 cm to 30 cm.

4. The HTS cable of claim 1, wherein the optical gratings of the plurality of optical gratings are fiber Bragg gratings.

5. The HTS cable of claim 1, wherein optical gratings of the plurality of optical gratings are spaced at a density of at least one optical grating per 20 cm.

6. The HTS cable of claim 1, wherein the high-temperature superconductor is a HTS tape stack.

7. The HTS cable of claim 6, wherein the HTS tape stack is embedded in a conductive former and the optical fiber is disposed within the conductive former, and wherein the conductive former comprises a cooling channel.

8. The HTS cable of claim 6, wherein the HTS tape stack is coupled to a conductive former and the optical fiber is coupled to the conductive former.

9. The HTS cable of claim 1, wherein the plurality of optical gratings are a plurality of fiber Bragg gratings (FBGs), and wherein the plurality of FBGs have respective center wavelengths linearly increasing along the length of the optical fiber.

10. The HTS cable of claim 1, further comprising a conductive former having a central cooling channel, wherein the high-temperature superconductor comprises a plurality of HTS tape stacks disposed outwardly of the central cooling channel, wherein each of the plurality of optical fibers includes a plurality of optical gratings arranged such that center wavelengths of respective optical gratings of the plurality of optical gratings increase linearly along a length of the respective optical fiber.

11. The HTS cable of claim 10, wherein the HTS cable comprises a plurality of optical fibers disposed proximate a periphery of the conductive former including the optical fiber.

12. The HTS cable of claim 10, wherein the HTS cable comprises a plurality of optical fibers disposed proximate a periphery of the central cooling channel.

13. The HTS cable of claim 10, further comprising a jacket surrounding the conductive former.

14. The HTS cable of claim 10, wherein the increase in center wavelength of the optical gratings along the length of the optical fiber is between approximately 0.01 nm and 10 nm per optical grating.

15. The HTS cable of claim 1 wherein the plurality of optical gratings are spaced at a density of at least one optical grating per 10 cm.

16. A high-temperature superconductor (HTS) cable, comprising:
an elongated conductive former having a centrally located cooling channel and a plurality of HTS tape stack channels disposed at its periphery;
a conductive jacket surrounding the elongated conductive former;
a plurality of HTS tape stacks disposed in respective HTS tape stack channels of the plurality of HTS tape stack channels; and
a plurality of optical fibers thermally coupled to the plurality of HTS tape stacks, each of at least two optical fibers of the plurality of optical fibers comprising a plurality of optical gratings of increasing center wavelength positioned along a length of the respective optical fiber.

17. The HTS cable of claim 16, wherein an optical fiber of the plurality of optical fibers is disposed at a periphery of the conductive jacket.

18. The HTS cable of claim 16, wherein an optical fiber of the plurality of optical fibers is disposed between an HTS tape stack of the plurality of HTS tape stacks and the centrally located cooling channel.

19. The HTS cable of claim 16, wherein the plurality of optical gratings of the at least two optical fibers of the plurality of optical fibers have center wavelengths that differ from neighboring optical gratings by between 0.01 nm and 10 nm.

20. The HTS cable of claim 16, wherein the plurality of HTS tape stacks includes four HTS tape stacks or five HTS tape stacks.

21-45. (canceled)
